(19) United States
(12) Patent Application Publication
(10) Pub. No.: US 2014/0313097 A1
(43) Pub. Date: Oct. 23, 2014

(54) GPS ANTENNA, MOTHERBOARD EMPLOYING SAME, AND WIRELESS COMMUNICATION DEVICE EMPLOYING MOTHERBOARD

(71) Applicant: Chiun Mai Communication Systems, Inc., New Taipei (TW)

(72) Inventors: CHANG-HSIN OU, New Taipei (TW); HSI-CHIEH CHEN, New Taipei (TW); CHO-KANG HSU, New Taipei (TW)

(73) Assignee: CHIUN MAI COMMUNICATION SYSTEMS, INC., New Taipei (TW)

(21) Appl. No.: 14/085,922

(22) Filed: Nov. 21, 2013

(30) Foreign Application Priority Data
Apr. 23, 2013 (TW) 102114287

(51) Int. Cl. H01Q 1/38; H01Q 1/36

(52) U.S. Cl. CPC H01Q 1/38; H01Q 1/36
USPC 343/845; 343/700 MS

(57) ABSTRACT

A global positioning system (GPS) antenna includes a feeding portion, a grounding portion, and a resonating member. The resonating member is connected to the feeding portion and the grounding portion. The resonating member includes a radiation body and defines a first slit and a second slit. The first slit and the second slit increase a distance of a current path of the resonating member. The GPS antenna is directly formed on a printed circuit board (PCB).

### BACKGROUND

1. Technical Field

The disclosure generally relates to antennas, and particularly to a global positioning system (GPS) antenna, a motherboard employing the GPS antenna, and a wireless communication device employing the motherboard.

2. Description of Related Art

A typical GPS antenna is a planar inverted-F antenna or a panel antenna. However, the planar inverted-F antenna and the panel antenna are usually large, which compromise efforts toward miniaturization of portable electronic devices.

Therefore, there is room for improvement within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the disclosure.

FIG. 1 is a schematic view of a motherboard employing an embodiment of a GPS antenna.

FIG. 2 is a diagram showing return loss (RL) measurement of the GPS antenna shown in FIG. 1.

### DETAILED DESCRIPTION

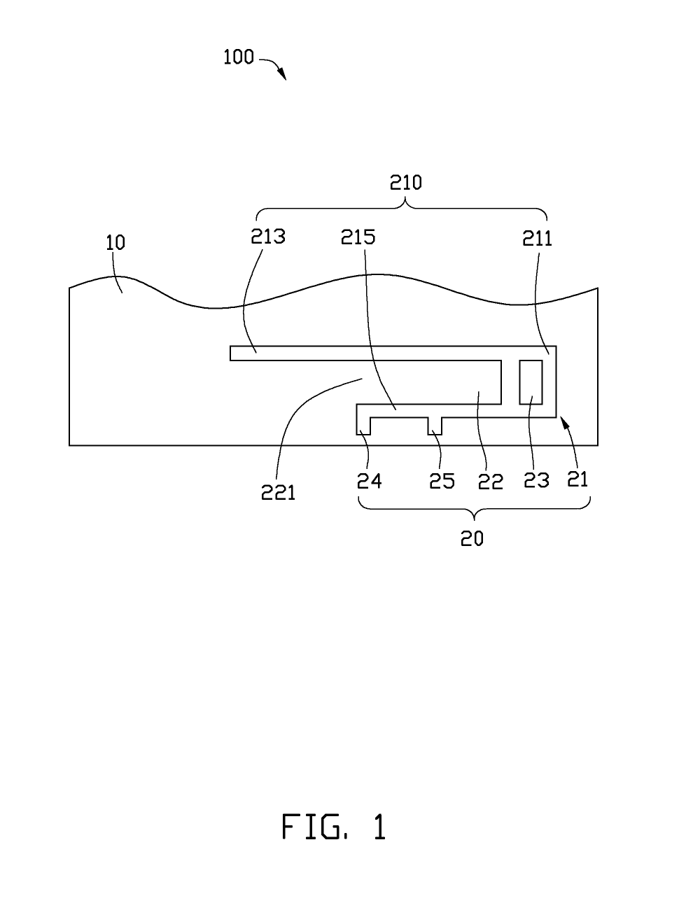

FIG. 1 is a schematic view of a motherboard 100 employing an embodiment of a GPS antenna 20. The motherboard 100 is used in a wireless communication device, such as a mobile phone or a tablet computer. The motherboard 100 includes a printed circuit board (PCB) 10 and a global positioning system (GPS) antenna 20. The GPS antenna 20 is formed by etching a copper foil on a surface of the PCB 10.

The GPS antenna 20 includes a resonating member 21, a grounding portion 24, and a feeding portion 25. The resonating member 21 is electronically connected to and grounded by the grounding portion 24. The resonating member 21 is further electronically connected to a signal feeding point (not shown) of the motherboard 100 via the feeding portion 25.

The resonating member 21 includes a radiation body 210, and defines a first slit 22 and a second slit 23. The radiation body 210 includes a first radiating portion 211, a second radiating portion 213, and a third radiating portion 215. The first radiating portion 211 is rectangular-frame-shaped. The second and the third radiating portions 213, 215 are strip-shaped. The second radiating portion 213 and the third radiating portion 215 are substantially parallel to each other and extend from a same side of the first radiating portion 211. The second radiating portion 213 is longer than the third radiating portion 215. The first, second, and third radiating portions 211, 213, and 215 cooperatively define a first slit 22. A second slit 23 is defined in a center portion of the first radiating portion 211.

The grounding portion 24 and the feeding portion 25 extend from the third radiating portion 215 away from the second radiating portion 213. The grounding portion 24 extends from a distal end of the third radiating portion 215. The feeding portion 25 is substantially parallel to the grounding portion 24 and extends from a middle portion of the third radiating portion 215. A shape and size of the first slit 22 and the second slit 23 can be adjusted to ensure that the GPS antenna 20 receives/transmits wireless signals at a central frequency of about 1575 megahertz (MHz).

In use, current transmitted to a portion of the radiation body 210 adjacent to the first slit 22 and the second slit 23 is enhanced, such that an electromagnetic field distribution of the resonating member 21 is adjusted, and an electromagnetic field power of the resonating member 21 is enhanced. The adjusted electromagnetic field distribution and the enhanced electromagnetic field power broaden a bandwidth of the GPS antenna 20. In addition, the presence of the first slit 22 and the second slit 23 increase a length of a current path of the radiation body 210. Thus, a size of the GPS antenna 20 is decreased.

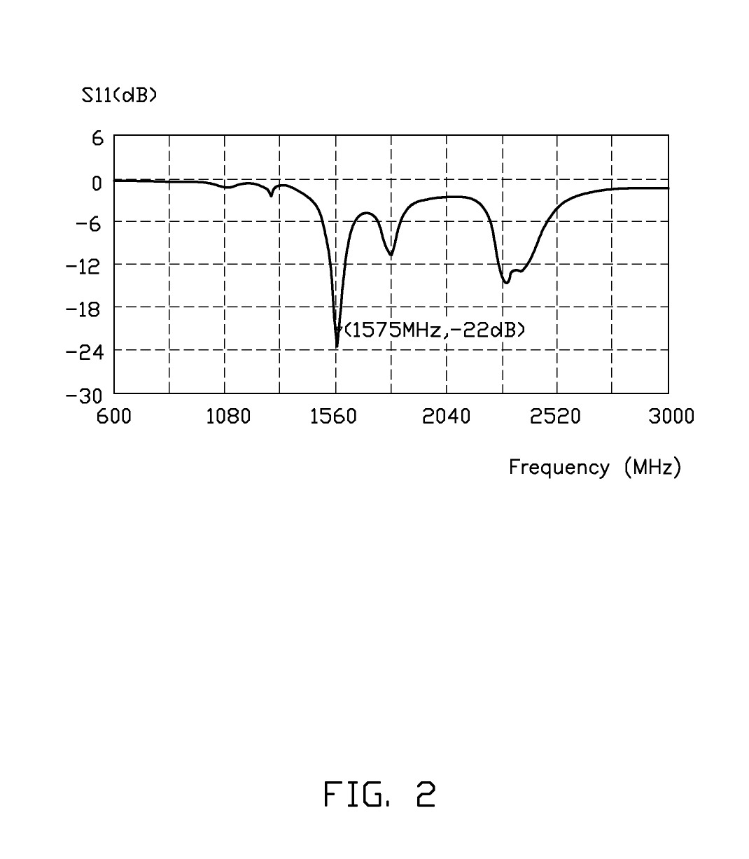

FIG. 2 is a return loss (RL) diagram of the GPS antenna 20. Table 1 below shows gains and radiation efficiencies of the GPS antenna 20 when the antenna receives/transmits wireless signals at different frequencies. As shown in table 1 and FIG. 2, the GPS antenna 20 achieves a high radiation efficiency of wireless signals at a GPS band of about 1575 MHz.

TABLE 1

| Frequency (MHz) | Gain (dB) | Radiation efficiency (%) |
|---|---|---|
| 1570 | −3.28 | 46.9 |
| 1575 | −3.72 | 42.6 |
| 1580 | −4.29 | 37.2 |

The GPS antenna 20 is a copper foil directly formed by etching on the PCB 10, thus reducing a required size of the GPS antenna 20. In addition, the current path of the radiation body 210 is increased by the first and second slits 22 and 23, thereby further reducing the required size of the GPS antenna 20. Therefore, the disclosure provides a GPS antenna to facilitate miniaturization of motherboards and wireless communication devices.

It is believed that the embodiments and their advantages will be understood from the foregoing description, and it will be apparent that various changes may be made thereto without departing from the spirit and scope of the disclosure or sacrificing all of its material advantages, the examples hereinbefore described merely being embodiments of the disclosure.

What is claimed is:

1. A global positioning system (GPS) antenna, comprising:
a feeding portion;
a grounding portion; and
a resonating member connected to the feeding portion and the grounding portion, the resonating member comprising a radiation body, and defining a first slit and a second slit;
wherein the first slit and the second slit are configured to increase a distance of a current path of the resonating member.

2. The GPS antenna of claim 1, wherein the radiation body comprises a first radiating portion, a second radiating portion, and a third radiating portion; the second radiating portion and the third radiating portion extend from the first radiating portion; the first slit is defined by the first radiating portion, the second radiating portion, and the third radiating portion; the second slit is defined in the first radiating portion.

3. The GPS antenna of claim 2, wherein the second radiating portion is substantially parallel with the third radiating portion, and the second radiating portion and the third radiating portion are positioned at the same side of the first radiating portion.

4. The GPS antenna of claim 3, wherein the first radiating portion is rectangular frame-shaped, the second radiating portion extends from a first end of the side of the first radiating portion, and the third radiating portion extends from a second end of the side of the first radiating portion.

5. The GPS antenna of claim 2, wherein the grounding portion and the feeding portion extend from the third radiating portion away from the second radiating portion; the grounding portion is positioned at a distal end of the third radiating portion; the feeding portion is substantially parallel with the grounding portion, and is positioned at a middle portion of the third radiating portion.

6. A motherboard, comprising:
a printed circuit board (PCB); and
a global positioning system (GPS) antenna directly formed on the PCB, the GPS antenna comprising:
a feeding portion;
a grounding portion; and
a resonating member connected to the feeding portion and the grounding portion, the resonating member comprising a radiation body, and defining a first slit and a second slit;
wherein the first slit and the second slit are configured to increase an electrical characteristic length of the resonating member.

7. The motherboard of claim 6, wherein the GPS antenna is formed by etching a copper foil on a surface of the PCB.

8. The motherboard of claim 6, wherein the radiation body comprises a first radiating portion, a second radiating portion, and a third radiating portion; the second radiating portion and the third radiating portion extend from the first radiating portion; the first slit is defined by the first radiating portion, the second radiating portion, and the third radiating portion; the second slit is defined in the first radiating portion.

9. The motherboard of claim 8, wherein the second radiating portion is substantially parallel with the third radiating portion, and the second radiating portion and the third radiating portion are positioned at the same side of the first radiating portion.

10. The motherboard of claim 9, wherein the first radiating portion is rectangular frame-shaped, the second radiating portion extends from a first end of the side of the first radiating portion, and the third radiating portion extends from a second end of the side of the first radiating portion.

11. The motherboard of claim 8, wherein the grounding portion and the feeding portion extend from the third radiating portion away from the second radiating portion; the grounding portion is positioned at a distal end of the third radiating portion; the feeding portion is substantially parallel with the grounding portion, and is positioned at a middle portion of the third radiating portion.

12. A wireless communication device, comprising:
a printed circuit board (PCB); and
a global positioning system (GPS) antenna directly formed on the PCB, the GPS antenna comprising:
a feeding portion;
a grounding portion; and
a resonating member connected to the feeding portion and the grounding portion, the resonating member comprising a radiation body, and defining a first slit and a second slit;
wherein the first slit and the second slit are configured to increase an electrical characteristic length of the resonating member.

13. The wireless communication device of claim 12, wherein the GPS antenna is formed by etching a copper foil on a surface of the PCB.

14. The wireless communication device of claim 13, wherein the radiation body comprises a first radiating portion, a second radiating portion, and a third radiating portion; the second radiating portion and the third radiating portion extend from the first radiating portion; the first slit is defined by the first radiating portion, the second radiating portion, and the third radiating portion; the second slit is defined in the first radiating portion.

15. The wireless communication device of claim 14, wherein the second radiating portion is substantially parallel with the third radiating portion, and the second radiating portion and the third radiating portion are positioned at the same side of the first radiating portion.

16. The wireless communication device of claim 15, wherein the first radiating portion is rectangular frame-shaped, the second radiating portion extends from a first end of the side of the first radiating portion, and the third radiating portion extends from a second end of the side of the first radiating portion.

17. The wireless communication device of claim 14, wherein the grounding portion and the feeding portion extend from the third radiating portion away from the second radiating portion; the grounding portion is positioned at a distal end of the third radiating portion; the feeding portion is substantially parallel with the grounding portion, and is positioned at a middle portion of the third radiating portion.
